(19) United States
(12) Patent Application Publication
(10) Pub. No.: US 2020/0026137 A1
(43) Pub. Date: Jan. 23, 2020

(54) LIQUID CRYSTAL DISPLAY DEVICE

(71) Applicant: SHARP KABUSHIKI KAISHA, Osaka (JP)

(72) Inventor: SHOTARO KANEYOSHI, Sakai City (JP)

(21) Appl. No.: 16/514,375

(22) Filed: Jul. 17, 2019

Related U.S. Application Data
(60) Provisional application No. 62/699,077, filed on Jul. 17, 2018.

(51) Int. Cl. G02F 1/1362; G02F 1/16766; G09G 3/36

(52) U.S. Cl. CPC G02F 1/136286; G02F 1/16766; G09G 2320/0233; G09G 3/3677; G09G 3/3648

(57) ABSTRACT

A liquid crystal display device includes a display panel having a plurality of pixels that is defined by a plurality of gate lines and a plurality of source lines and is each provided with a switching element and a pixel electrode. The liquid crystal display device further includes a gate line drive circuit configured to scan the gate lines, and a source line drive circuit configured to supply each of the source lines with a data signal by means of column inversion driving. The gate line drive circuit divides the plurality of gate lines into at least two groups, and sequentially scans the gate lines once per group in one frame. The at least two groups include a group of the gate lines scanned in the one frame in a first direction in which the gate lines are aligned, and a group of the gate lines scanned in a second direction opposite to the first direction.

### TECHNICAL FIELD

The invention disclosed hereinafter relates to a liquid crystal display device and particularly relates to a liquid crystal display device configured to display an image in accordance with a column inversion driving system.

### BACKGROUND ART

There have been conventionally known driving methods including inverting polarity of data voltage supplied to pixels per unit time in a liquid crystal display device, in order to decrease deterioration of a liquid crystal material. Examples of such driving methods include dot inversion driving and column inversion driving. JP 2010-102189 A discloses a liquid crystal display device decreasing luminance gradient, crosstalk, and the like, by means of dot inversion driving or column inversion driving. This liquid crystal display device includes two scanning lines disposed in one pixel row, and data lines winding so as to be each shared by two transversely adjacent sub pixels. In this liquid crystal display device, the two scanning lines in the one pixel row are each driven for a half of a horizontal scanning period, and data voltage is applied to each of the sub pixels connected to a driven one of the scanning lines. This liquid crystal display device controls each of the data lines to have midpoint potential before selection of one of the scanning lines in order to decrease leakage current of a switching element provided at each of the pixels, caused by difference between data voltage in a foregoing frame kept at each of the pixels and data voltage in a subsequent frame.

The liquid crystal display device according to JP 2010-102189 A controls the data lines to have the midpoint potential before selection of one of the scanning lines so as not to be influenced by data voltage supplied before scanning, and thus achieves crosstalk reduction. The data lines need to be controlled to have the midpoint potential before each of the scanning lines is scanned in this case, which leads to increase of processing relevant to driving of the data lines.

### SUMMARY OF INVENTION

In order to solve the problem mentioned above, disclosed hereinafter is a liquid crystal display device including a display panel, the display panel including a plurality of gate lines, a plurality of source lines crossing the plurality of gate lines, a plurality of pixels defined by the plurality of gate lines and the plurality of source lines, a plurality of switching elements each provided at a corresponding one of the pixels and connected to a corresponding one of the gate lines and a corresponding one of the source lines for the pixel, and a plurality of pixel electrodes each provided at a corresponding one of the pixels and connected to the switching element at the pixel, the liquid crystal display device further including: a gate line drive circuit configured to scan the plurality of gate lines; and a source line drive circuit configured to supply each of the source lines with a data signal; in which the source line drive circuit supplies the data signals inverted in polarity to adjacent ones of the source lines, the data signals being inverted in polarity per frame, the gate line drive circuit divides the plurality of gate lines into at least two groups, and sequentially scans the gate lines once per group in one frame, and the at least two groups include a group of the gate lines scanned in the one frame in a first direction in which the plurality of gate lines is aligned, and a group of the gate lines scanned in a second direction opposite to the first direction.

The above configuration decreases crosstalk even when column inversion driving is executed.

### BRIEF DESCRIPTION OF DRAWINGS

FIG. 1 is a sectional view showing a schematic configuration of a liquid crystal display device according to an embodiment.

FIG. 2 is a plan view showing a schematic configuration of an active matrix substrate shown in FIG. 1.

FIG. 3 is a pattern diagram showing pixels in a display region shown in FIG. 2.

FIG. 4 is an equivalent circuit diagram of part of the pixels shown in FIG. 3.

FIG. 5 is a pattern diagram indicating polarity of data signals of the pixels in one frame.

FIG. 6A is a timing chart indicating source voltage, drain voltage, and potential difference between a source and a drain of each TFT in a case where gate lines are driven in a conventional scan order.

FIG. 6B is a chart indicating relation between ΔVmax periods and leakage current amounts in the case where the gate lines are driven in the conventional scan order.

FIG. 6C is a chart indicating, in addition to values exemplified in FIG. 6B, average values of ΔVmax periods (Av_ΔVmax periods) of TFTs connected to the gate lines adjacent to each other.

FIG. 7A is a pattern diagram indicating a scan order according to a first embodiment.

FIG. 7B is a chart indicating ΔVmax periods and Av_ΔVmax periods in a case where the gate lines are driven in the scan order indicated in FIG. 7A.

FIG. 8 is a pattern diagram indicating a scan order of gate lines in an (N+1)-th frame in a second embodiment.

FIG. 9 is a chart indicating ΔVmax periods, Av_ΔVmax periods, and averages of the ΔVmax periods in an N-th frame and the (N+1)-th frame in the second embodiment.

FIG. 10A is a chart indicating a scan order, ΔVmax periods, Av_ΔVmax periods, and adjacent line difference in a case where gate lines are divided into four groups in a modification example (1).

FIG. 10B is a chart indicating a scan order, ΔVmax periods, Av_ΔVmax periods, and adjacent line difference in a case where the gate lines are divided into eight groups in the modification example (1).

FIG. 11A is a chart according to a comparative example of the modification example (1), indicating ΔVmax periods, Av_ΔVmax periods, and adjacent line difference in the case where the gate lines are driven in the conventional scan order.

FIG. 11B is a chart according to another comparative example of the modification example (1), indicating a scan order, ΔVmax periods, Av_ΔVmax periods, and adjacent line difference in a case where the gate lines are divided into two groups.

FIG. 12 is a chart indicating a scan order of gate lines, ΔVmax periods, and average values of the ΔVmax periods according to a modification example (2).

### DESCRIPTION OF EMBODIMENTS

A liquid crystal display device according to a first configuration includes a display panel, the display panel including a plurality of gate lines, a plurality of source lines crossing the plurality of gate lines, a plurality of pixels defined by the plurality of gate lines and the plurality of source lines, a plurality of switching elements each provided at a corresponding one of the pixels and connected to a corresponding one of the gate lines and a corresponding one of the source lines for the pixel, and a plurality of pixel electrodes each provided at a corresponding one of the pixels and connected to the switching element at the pixel, and the liquid crystal display device further includes: a gate line drive circuit configured to scan the plurality of gate lines; and a source line drive circuit configured to supply each of the source lines with a data signal; in which the source line drive circuit supplies the data signals inverted in polarity to adjacent ones of the source lines, the data signals being inverted in polarity per frame, the gate line drive circuit divides the plurality of gate lines into at least two groups, and sequentially scans the gate lines once per group in one frame, and the at least two groups include a group of the gate lines scanned in the one frame in a first direction in which the plurality of gate lines is aligned, and a group of the gate lines scanned in a second direction opposite to the first direction.

According to the first configuration, the liquid crystal display device includes the display panel having the plurality of pixels that is defined by the plurality of gate lines and the plurality of source lines and is each provided with the switching element and the pixel electrode. The liquid crystal display device includes the gate line drive circuit configured to scan the gate lines and the source line drive circuit configured to supply each of the source lines with the data signal. The data signals supplied to the adjacent source lines are inverted in polarity, and the polarity of the data signal supplied to each of the source lines is inverted per frame. There is thus generated potential difference between voltage of the data signal kept at each of the pixels before a corresponding one of the gate lines is scanned in a foregoing frame and voltage of the data signal supplied before the gate line is scanned in a subsequent frame, and the switching element connected to the gate line has a flow of leakage current. The switching elements connected to the different gate lines each have different timing of scanning the corresponding gate line, and thus each have a different period of influence by the data signal supplied before the gate line is scanned. As time until the switching element comes into an ON state, in other words, time until the gate line is scanned (hereinafter, referred to as scanning standby time), is longer in one frame, the switching element is influenced by the data signal for a longer period and thus has a larger leakage current amount. In a case where the gate lines are scanned in an order of alignment of the gate lines, the gate line to be scanned later has longer scanning standby time and pairs of adjacent gate lines in all the gate lines thus have variation in average of the scanning standby time. An entire pixel region accordingly includes pixel rows having relatively short scanning standby time and pixel rows having relatively long scanning standby time, and has crosstalk caused by difference in leakage current amount.

According to the first configuration, the plurality of gate lines is divided into the at least two groups including the group having the first direction of scanning the gate lines in one frame and the group having the second direction opposite to the first direction. The gate lines are scanned once per group in one frame. In other words, the gate lines in at least part of the groups are scanned in the direction opposite to the direction of the remaining groups. In comparison to the case where the gate lines are scanned in the order of alignment of the gate lines, the pairs of adjacent gate lines in all the gate lines have smaller variation in average of the scanning standby time to achieve reduction of crosstalk caused by difference in leakage current amount.

In the first configuration, the at least two groups may include a first group of the gate lines in odd rows and a second group of the gate lines in even rows (a second configuration).

According to the second configuration, the plurality of gate lines to be scanned is divided into the first group including the gate lines in the odd rows and the second group including the gate lines in the even rows. The gate lines in the first group and the gate lines in the second group are scanned in the directions opposite to each other. In comparison to the case where the gate lines are scanned in the order of alignment of the gate lines, the pairs of adjacent gate lines in all the gate lines have further smaller variation in average of the scanning standby time, so that crosstalk caused by difference in leakage current amount is less likely to occur.

In the second configuration, the gate line drive circuit may switch scan directions of the first group and the second group per frame (a third configuration).

In a case where the entire pixel region includes adjacent pixel rows having relatively large difference in leakage current amount, the adjacent pixel rows have luminance difference that may cause horizontal line and deterioration in display quality. In a case where the first group and the second group have fixed scan directions, the adjacent pixel rows having relatively large difference in leakage current amount are fixed and are thus likely to have horizontal line caused by luminance difference. According to the third configuration, the scan directions of the first group and the second group are switched per frame. The adjacent pixel rows having relatively large difference in leakage current amount are not fixed in this case and are thus less likely to have horizontal line.

Optionally, in the second or third configuration, the gate line drive circuit includes a plurality of first shift registers respectively connected to the gate lines in the first group and configured to scan the connected gate lines, and a plurality of second shift registers respectively connected to the gate lines in the second group and configured to scan the connected gate lines, and the plurality of first shift registers is disposed in a frame region at first ends of the gate lines, and the plurality of second shift registers is disposed in the frame region at second ends of the gate lines (a fourth configuration).

According to the fourth configuration, the first shift registers configured to scan the gate lines in the first group and the second shift registers configured to scan the gate lines in the second group are disposed in the frame region respectively at the ends of the gate lines. The frame region can thus be narrowed in comparison to a case where all the shift registers are disposed in the frame region at either one of the ends of the gate lines.

Optionally, in the first configuration, the at least two groups include at least three groups, and each of the at least three groups includes the gate lines scanned in the one frame in a direction opposite to a direction of scanning the gate lines in groups foregoing or subsequent in scan order (a fifth configuration).

According to the fifth configuration, the scan direction of the gate lines in each of the groups in one frame is opposite to the scan direction in groups foregoing or subsequent in scan order. In comparison to the case where the gate lines are scanned in the order of alignment of the gate lines, the pairs of adjacent gate lines in all the gate lines have further smaller variation in average of the scanning standby time, so that crosstalk caused by difference in leakage current amount is less likely to occur.

### First Embodiment

An embodiment of the invention will now be described in detail with reference to the drawings. Identical or corresponding parts in the drawings will be denoted by identical reference signs and will not be described repeatedly. For clearer description, the drawings to be referred to below may depict simplified or schematic configurations or may not include some of constituent elements. The constituent elements in each of the drawings may not necessarily be shown in actual dimensional ratios.

(Configuration of Liquid Crystal Display Device)

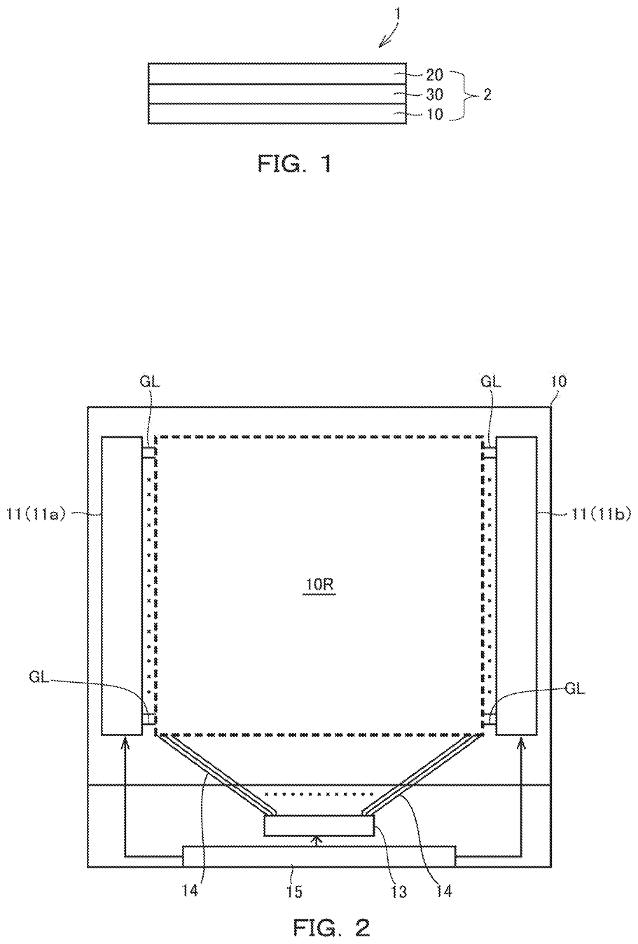

FIG. 1 is a pattern diagram showing a schematic configuration of a liquid crystal display device according to the present embodiment. FIG. 1 depicts a liquid crystal display device 1 including a display panel 2 having an active matrix substrate 10, a counter substrate 20, and a liquid crystal layer 30 interposed between the active matrix substrate 10 and the counter substrate 20.

Though not shown, there is provided a pair of polarizing plates on a lower surface of the active matrix substrate 10 and an upper surface of the counter substrate 20. The counter substrate 20 is provided with color filters (not shown) in three colors including red (R), green (G), and blue (B).

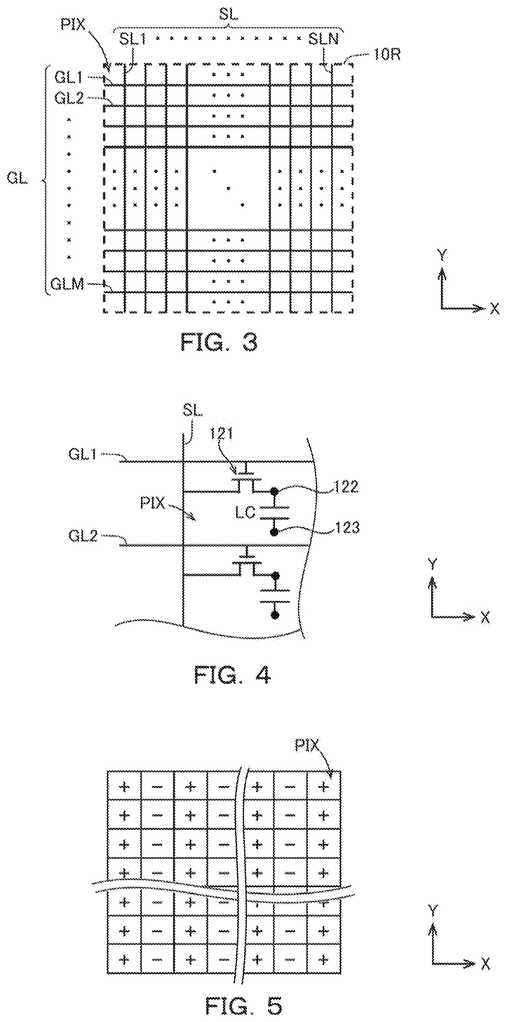

FIG. 2 is a pattern diagram showing a schematic configuration of the active matrix substrate 10. As shown in FIG. 2, the active matrix substrate 10 has a display region 10R. There is provided, outside the display region 10R, gate drivers 11 (11a and 11b), a source driver 13, wires 14, and a terminal 15.

The gate drivers 11 and the source driver 13 are electrically connected to the terminal 15. The source driver 13 is connected to the wires 14. The terminal 15 receives, from a display control circuit (not shown), timing signals, control signals, and the like causing the gate drivers 11 and the source driver 13 to be driven.

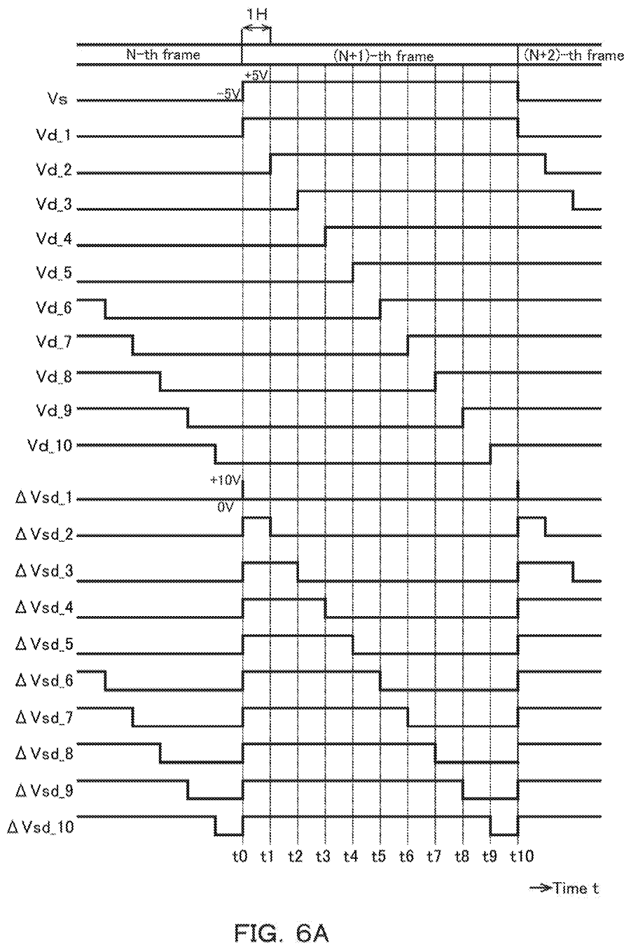

FIG. 3 is a pattern diagram showing a schematic configuration of the display region 10R. As shown in FIG. 3, the display region 10R includes a plurality of pixels PIX defined by a plurality of gate lines GL (GL1 to GLM) and a plurality of source lines SL (SL1 to SLN) crossing the gate lines GL. The display region 10R has pixel rows that are adjacent to the gate line GL1 and are referred to as pixel rows in an upper or front portion, and pixel rows that are adjacent to the gate line GLM and are referred to as pixel rows in a lower or rear portion.

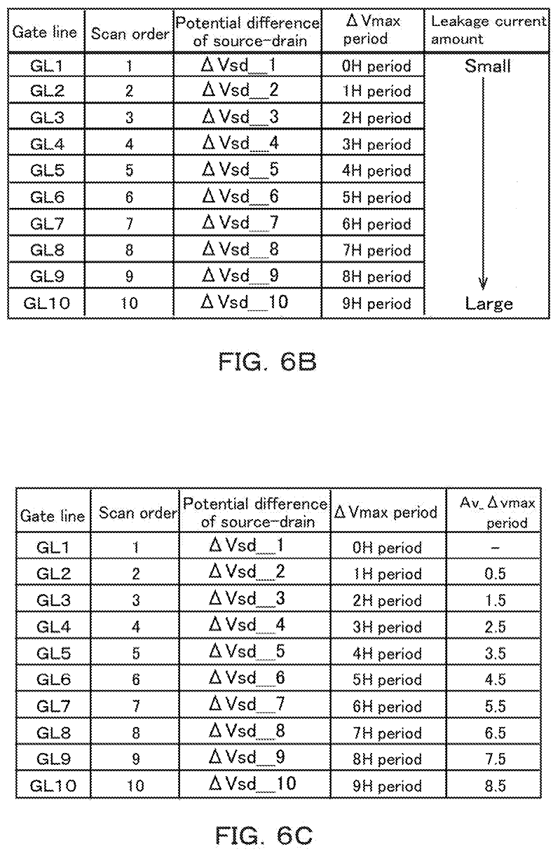

FIG. 4 depicts a schematic configuration of part of the pixels in the display region 10R. The pixels PIX are each provided with a thin film transistor (TFT) 121, a pixel electrode 122, and a common electrode 123. The common electrode 123 is configured by a transparent conductive film made of ITO or the like, and is disposed to face the pixel electrode 122 with an insulating film interposed therebetween. The pixel electrode 122 and the common electrode 123 form liquid crystal capacitance LC provided therebetween. In this exemplary case, the pixel electrode 122 and the common electrode 123 are provided on the active matrix substrate 10, and the liquid crystal layer 30 is driven in accordance with a transverse electric field system. The TFTs 121 each have a gate connected to a corresponding one of the gate lines GL, a source connected to a corresponding one of the source lines SL, and a drain connected to the pixel electrode 122.

The gate lines GL are connected to the gate driver 11a or 11b (FIG. 2). In this exemplary case as shown in FIG. 2, the gate driver 11a is disposed at left ends of the gate lines GL on the sheet whereas the gate driver 11b is disposed at right ends of the gate lines GL.

The gate driver 11a has a plurality of shift registers (not shown) respectively connected to the gate lines GL in odd rows. The gate driver 11b has a plurality of shift registers (not shown) respectively connected to the gate lines GL in even rows.

Each of the gate drivers 11a and 11b sequentially applies selection voltage to the connected gate lines GL in accordance with timing signals received from the display control circuit (not shown) via the terminal 15. Applying the selection voltage to the gate lines GL may hereinafter be expressed as driving or scanning the gate lines GL.

The source lines SL (see FIG. 3 or 4) are connected to the source driver 13 via the wires 14 (see FIG. 2). The source lines SL each receive a data voltage signal from the source driver 13 via the wire 14.

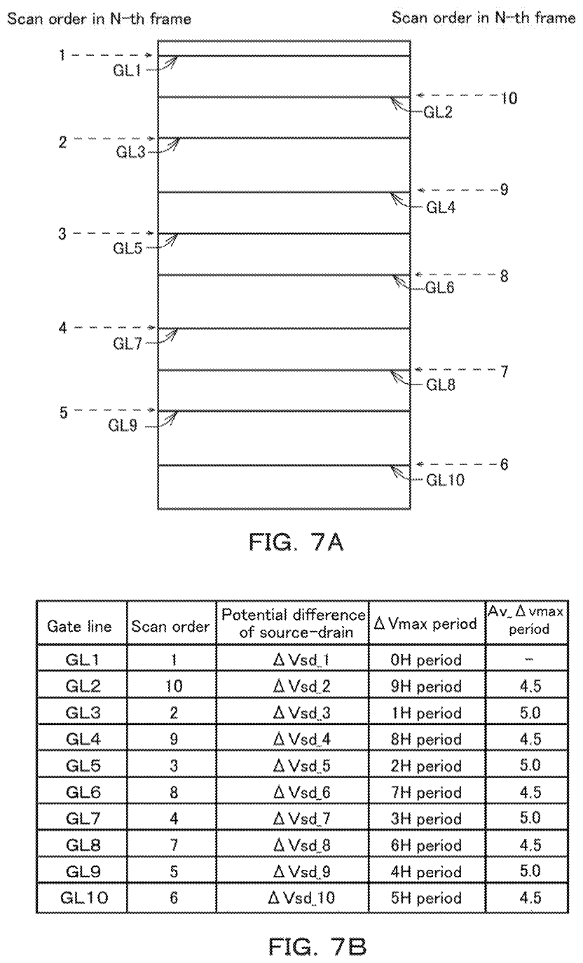

The data voltage signal has either positive polarity or negative polarity with respect to potential of the common electrode 123 (see FIG. 4). The source driver 13 supplies the data voltage signal to each of the source lines SL in accordance with the column inversion driving system. The source lines SL adjacent to each other receive the data voltage signals inverted in polarity, and the polarity of the data voltage signal applied to each of the source lines SL is inverted per frame. As indicated in FIG. 5, in each frame, the pixels PIX adjacent to each other in a row direction (X direction) have data voltage inverted in polarity, whereas the pixels PIX adjacent to each other in a column direction (Y direction) have data voltage equal in polarity.

When the data voltage signal is applied to the source of the TFT 121 (see FIG. 4) in an ON state, the drain of the TFT 121 keeps voltage of the data voltage signal. Current does not flow from the source to the drain even if the data voltage signal is applied to the source of the TFT 121 in an OFF state. However, leakage current flows from the drain to the source if there is potential difference between the source and the drain. Such leakage current is more likely to flow with larger potential difference between the source and the drain of the TFT 121. When the gate lines GL1 to GLM are driven sequentially, the TFT 121 connected to the gate line GL in the rear portion has larger leakage current. Display of a halftone image particularly leads to crosstalk (vertical shadow) caused by difference in leakage current. Specifically described below is a reason therefor.

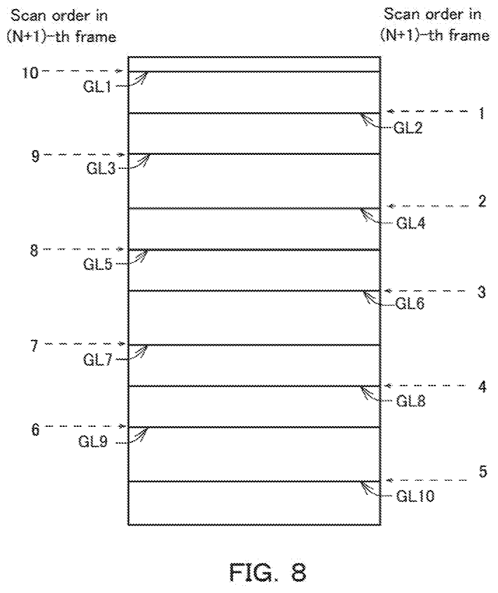

FIG. 6A is a timing chart indicating potential difference (ΔVsd) between the source and the drain of each of the TFTs 121 connected to the gate lines GL in a case where the gate lines GL1 to GLM are sequentially driven every horizontal scanning period (1 H) or the like in one frame. In this exemplary case, the gate lines GL include ten gate lines for convenience.

As exemplified in FIG. 6A, the data voltage signal supplied to a certain one of the source lines SL has voltage Vs changing to −5 V in an N-th frame and to +5 V in an (N+1)-th frame. That is, this source line SL receives data voltage having negative polarity in the N-th frame and receives data voltage having positive polarity in the (N+1)-th frame.

When each of the gate lines GL1 to GL10 connected to the TFTs 121 is driven, the corresponding TFT 121 comes into the ON state, current flows from the source to the drain of the TFT 121, and the drain has potential Vd equal to the potential of the source voltage Vs. When the gate line GL connected to the TFT 121 subsequently comes into a non-selected state, the TFT 121 is brought into the OFF state and the drain potential is kept. As indicated in FIG. 6A, the TFTs 121 connected to the gate lines GL1 to GL10 have drain potential Vd_1 to Vd_10 sequentially reaching +5 V at timing shifted by one horizontal scanning period. Each of the TFTs 121 has +10 V as the potential difference ΔVsd between the source and the drain until the TFT 121 comes into the ON state, but the TFTs 121 are different from each other in duration of the potential difference at +10 V.

Specifically, the TFT 121 connected to the gate line GL1 has potential difference ΔVsd_1 changing from 0 V to +10 V at time t0. The gate line GL1 is driven substantially simultaneously with the change and the potential difference thus has +10 V instantaneously. In contrast, the TFT 121 connected to the gate line GL10 has potential difference ΔVsd_10 changing from 0 V to +10 V at the time t0 and kept at +10 V until time t9 when the gate line GL10 is driven.

The TFT 121 connected to the gate line GL10 has a flow of larger leakage current, with the period of the potential difference ΔVsd kept at +10 V, in other words, a period of the potential difference kept at a maximum potential difference ΔVmax (hereinafter, referred to as a ΔVmax period), being longer by about nine horizontal scanning periods in comparison to the TFT 121 connected to the gate line GL1.

FIG. 6B is a chart indicating relation between the ΔVmax periods of the potential difference ΔVsd_1 to ΔVsd_10 and leakage current amounts.

When the gate lines GL1 to GL10 are driven in the mentioned order, the TFT 121 connected to the gate line GL in the rear portion has a longer ΔVmax period and a larger leakage current amount. An entire pixel region includes a portion with relatively small leakage current amounts and a portion with relatively large leakage current amounts to generate crosstalk (vertical shadow) in this case. Crosstalk is more likely to occur with larger variation (difference) in average of the ΔVmax periods in one frame of the TFTs 121 in pairs of pixel rows adjacent to each other in the entire pixel region, in other words, in average of scanning standby time of all the pairs of adjacent gate lines GL in all the gate lines GL.

The gate lines GL according to the present embodiment are scanned so as to decrease variation in average of the ΔVmax periods among all the pairs of the adjacent pixel rows. As described above, crosstalk is more likely to occur with larger variation in average of the scanning standby time among all the pairs of the adjacent gate lines GL. Adopted hereinafter as an index of crosstalk reducing effect (or likelihood) is difference between a maximum value and a minimum value of average values of the ΔVmax periods (Av_ΔVmax periods) of the TFTs 121 in pairs of pixel rows adjacent to each other. As the difference between the maximum value and the minimum value of the Av_ΔVmax periods is smaller, the TFTs 121 in the adjacent pixel rows have more averaged leakage current amounts and achieve higher crosstalk reducing effect.

FIG. 6C indicates the Av_ΔVmax periods in a case where the gate lines are driven in a conventional scan order indicated in FIG. 6B referred to earlier, in which case the difference between the maximum value and the minimum value of the Av ΔVmax periods is 8.0 H (=8.5-0.5). The Av_ΔVmax periods vary in a range of 8.0 H when the gate lines are driven in the conventional scan order.

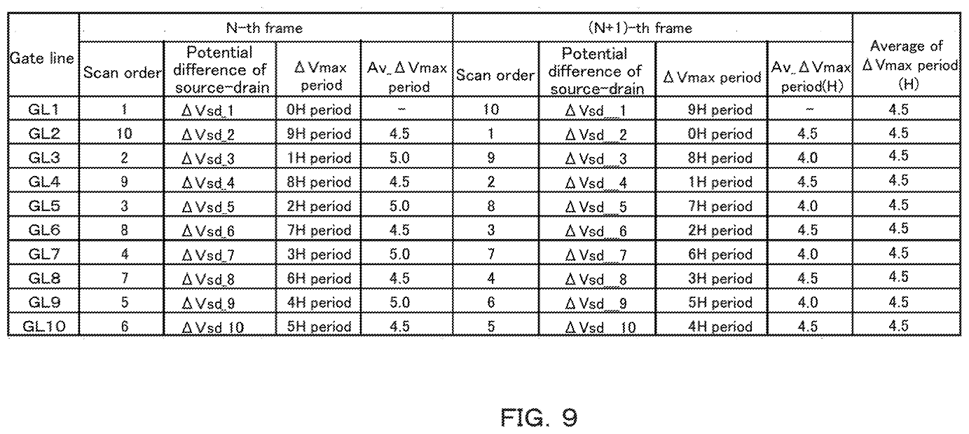

Described below is an order of scanning the gate lines GL according to the present embodiment, for achievement of higher crosstalk reducing effect in comparison to the conventional case. FIG. 7A is a pattern diagram indicating the order of scanning the gate lines GL according to the present embodiment.

As indicated in FIG. 7A according to the present embodiment, in each frame, the gate driver 11a drives the gate lines GL in the odd rows in an order of the gate lines GL1, GL3, GL5, GL7, and GL9, and the gate driver 11b subsequently drives the gate lines GL in the even rows in an order of the gate lines GL10, GL8, GL6, GL4, and GL2.

In this case, the display control circuit (not shown) supplies a gate start pulse as a timing signal to the shift register (not shown) connected to the gate line GL1 and provided in the gate driver 11a. The shift registers (not shown) in the gate driver 11a sequentially apply selection voltage to the gate lines GL1, GL3, GL5, GL7, and GL9. When the gate line GL9 is driven, the display control circuit (not shown) supplies a gate start pulse to the shift register (not shown) connected to the gate line GL10 and provided in the gate driver 11b. The shift registers (not shown) in the gate driver 11b sequentially apply selection voltage to the gate lines GL10, GL8, GL6, GL4, and GL2.

FIG. 7B is a chart indicating the ΔVmax periods and the Av_ΔVmax periods of the potential difference ΔVsd_1 to ΔVsd_10 in the case where the gate lines GL are driven in the scan order indicated in FIG. 7A.

As indicated in FIG. 7B, the ΔVmax periods of the potential difference ΔVsd_1 to ΔVsd_10 do not change at a constant rate. In this case, the Av_ΔVmax periods of the TFTs 121 in the adjacent pixel rows are 4.5 H or 5.0 H, and the difference between the maximum value and the minimum value of the Av_ΔVmax periods is 0.5 H (=5.0−4.5).

When the gate lines are driven in the scan order according to the present embodiment, the difference between the maximum value and the minimum value of the Av_ΔVmax periods is smaller and the Av_ΔVmax periods are averaged in comparison to the case where the gate lines are driven in the conventional scan order. In other words, the leakage current amounts in one frame of the TFTs 121 in the adjacent pixel rows are more averaged in the entire pixel region in comparison to the conventional case. This leads to less outstanding luminance difference between the pixels caused by difference in leakage current amount to achieve crosstalk reduction.

### Second Embodiment

The first embodiment described above achieves reduction of crosstalk (vertical shadow) by dividing the gate lines GL1 to GLM into the gate lines in the odd rows and the gate lines in the even rows and driving the gate lines in the odd rows and the gate lines in the even rows such that the gate lines in the odd rows and the gate lines in the even rows are scanned in the directions opposite to each other. In the exemplary case of FIG. 7B, the adjacent pixel rows corresponding to the gate lines GL1 to GL5 have relatively large difference in ΔVmax period, and these pixel rows may have horizontal line caused by luminance difference.

In view of this, the present embodiment includes inverting, per frame, scan directions of the gate lines in the odd rows and the gate lines in the even rows and switching, per frame, driving orders of the gate lines in the odd rows and the gate lines in the even rows.

In the N-th frame, the gate driver 11a drives the gate lines GL in the odd rows in the order of the gate lines GL1, GL3, GL5, GL7, and GL9, and the gate driver 11b subsequently drives the gate lines GL in the even rows in the order of the gate lines GL10, GL8, GL6, GL4, and GL2, as indicated in FIG. 7A referred to earlier.

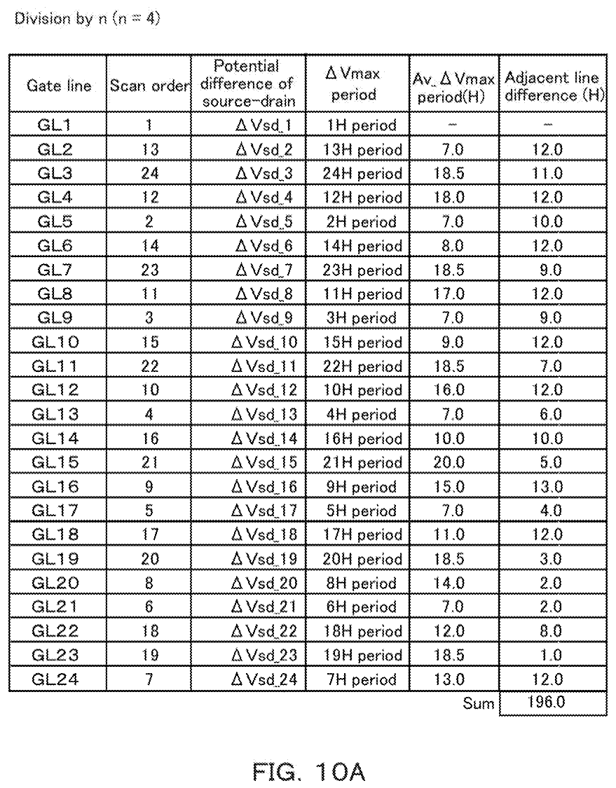

Subsequently in the (N+1)-th frame, the gate lines in the even rows are initially driven and the gate lines in the odd rows are driven thereafter, in the orders inverted from the orders in the N-th frame. As indicated in FIG. 8, the gate driver 11b initially drives the gate lines GL in the even rows in an order of the gate lines GL2, GL4, GL6, GL8, and GL10, and the gate driver 11a subsequently drives the gate lines GL in the odd rows in an order of the gate lines GL9, GL7, GL5, GL3, and GL1.

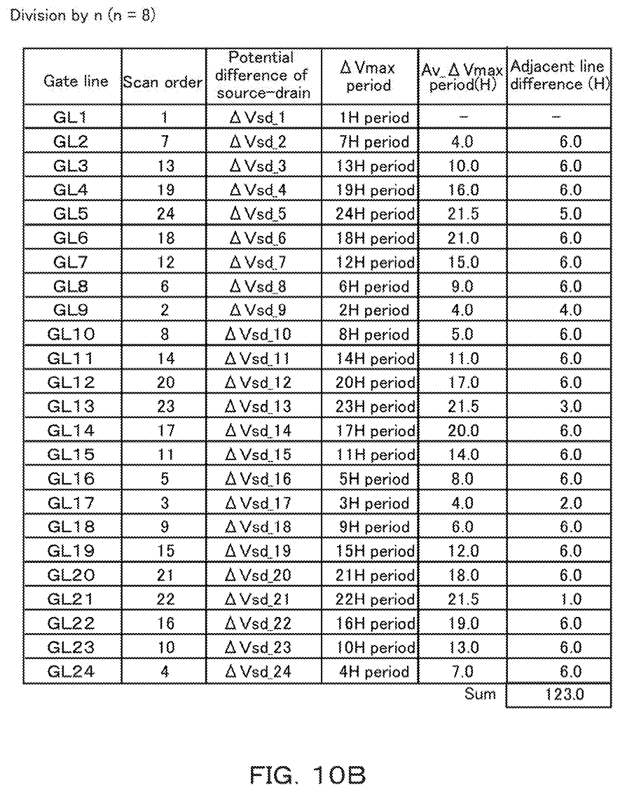

FIG. 9 is a chart indicating the ΔVmax periods and the Av_ΔVmax periods of the potential difference ΔVsd_1 to ΔVsd_10 in the N-th frame and the (N+1)-th frame, as well as averages of the ΔVmax periods in the two frames. FIG. 9 indicates the ΔVmax periods and the Av_ΔVmax periods in the N-th frame, which are similar to those indicated in FIG. 7B. The (N+1)-th frame has the order of scanning the gate lines GL different from that of the N-th frame, and thus has the ΔVmax periods and the Av_ΔVmax periods of the potential difference ΔVsd_1 to ΔVsd_10 different from those of the N-th frame. However, the (N+1)-th frame also has 0.5 H as the difference between the maximum value and the minimum value of the Av_ΔVmax periods, and achieves crosstalk reducing effect similar to that of the N-th frame.

The ΔVmax periods of the pixel rows in the two frames of the N-th frame and the (N+1)-th frame have an average of 4.5 H. That is, the ΔVmax periods of the TFTs 121 in all the pixel rows are uniformized through the plurality of frames. The leakage current amounts of the TFTs 121 in the pixel rows are also uniformized through the plurality of frames to have less outstanding luminance difference between the adjacent pixel rows and reduce deterioration in display quality such as horizontal line.

### MODIFICATION EXAMPLES

The liquid crystal display device according to any one of the embodiments described above is merely exemplified herein. The liquid crystal display device should not be limited to any one of the above embodiments, but can be implemented with appropriate modifications to the above embodiments without departing from the spirit of the invention.

(1) The second embodiment includes switching the driving orders of the gate lines in the odd rows and the gate lines in the even rows per frame and inverting the scan directions of the gate lines in the odd rows and the gate lines in the even rows per frame, to uniformize the leakage current amounts of the pixel rows through the plurality of frames and reduce horizontal line. The present modification example achieves reduction of horizontal line in a driving method different from that according to the second embodiment.

The present modification example adopts, as an index of horizontal line reducing effect, a sum of difference between the ΔVmax periods of the TFTs 121 in pairs of adjacent pixel rows (referred to as “adjacent line difference”). As the sum of the adjacent line difference decreases, the adjacent pixel rows have smaller difference in leakage current amount to achieve higher horizontal line reducing effect. The driving method according to the present modification example will be specifically described below.

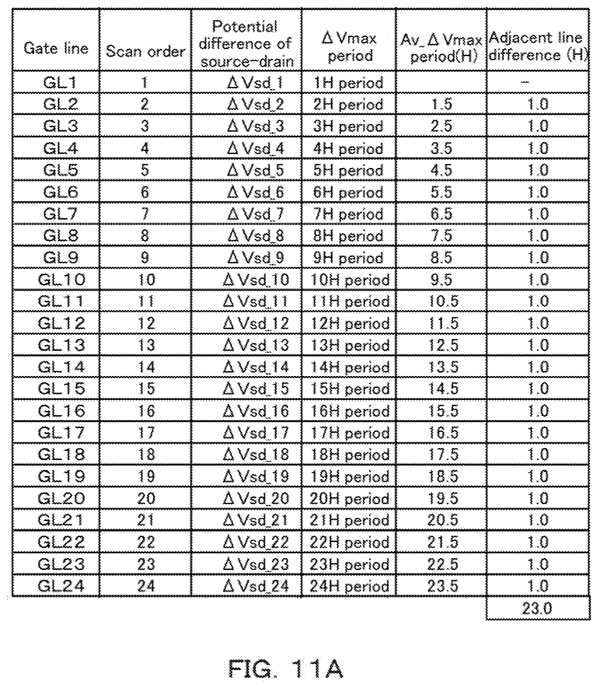

FIG. 10A is a chart indicating a scan order of the gate lines GL, the ΔVmax periods and the Av_ΔVmax periods of the TFTs 121 connected to the gate lines GL, and the adjacent line difference in a case where the gate lines GL1 to GLM are divided into four groups (G1 to G4) to be driven. FIG. 10B is a chart indicating a scan order of the gate lines GL, the ΔVmax periods and the Av_ΔVmax periods of the TFTs 121 connected to the gate lines GL, and the adjacent line difference in a case where the gate lines GL1 to GLM are divided into eight groups (G1 to G18) to be driven. FIGS. 10A and 10B exemplify a case where the gate lines GL include 24 gate lines for convenience. The invention is, however, not limited to this case in terms of the number of the gate lines GL.

FIG. 10A exemplifies the groups G1 to G4 including the gate lines GL as follows.

### G1={GL1, GL5, GL9, GL13, GL17, GL21, GL24}

### G2={GL2, GL4, GL8, GL12, GL16, GL20}

### G3={GL3, GL7, GL11, GL15, GL19, GL23}

### G4={GL6, GL10, GL14, GL18, GL22}

In this exemplary case, the gate lines GL are sequentially driven per group in an order of the groups G1, G2, G3, and G4. Specifically, the gate lines in the group G1 are initially driven sequentially, the gate lines in the group G2 are subsequently driven sequentially, the gate lines in the group G3 are then driven sequentially, and the gate lines in the group G4 are lastly driven sequentially.

The gate lines in the groups G1 and G3 have a first scan direction from the gate line GL1 toward the gate line GL24, whereas the gate lines in the groups G2 and G4 have a second scan direction opposite to the first scan direction of the groups G1 and G3. When the gate lines in the groups G1 to G4 are driven, the difference between the maximum value and the minimum value of the Av_ΔVmax periods is 13.0 H (=20.0−7.0), and the sum of the adjacent line difference is 196 H, as indicated in FIG. 10A.

FIG. 10B exemplifies the groups G11 to G18 including the gate lines GL as follows.

### G11={GL1, GL9, GL17, GL24}

### G12={GL2, GL8, GL16}

### G13={GL10, GL18, GL23}

### G14={GL3, GL7, GL15}

### G15={GL11, GL19, GL22}

### G16={GL4, GL6, GL14}

### G17={GL12, GL20, GL21}

### G18={GL5, GL13}

In this exemplary case, the gate lines GL are sequentially driven per group in an order of the groups G11, G12, G13, G14, G15, G16, G17, and G18. The gate lines in each of the groups G11 to G18 have a scan direction opposite to the scan direction of foregoing and subsequent groups. Specifically, the gate lines in the groups G11, G13, G15, and G17 have the first scan direction whereas the gate lines in the groups G12, G14, G16, and G18 have the second scan direction. When the gate lines in the groups G11 to G18 are driven in the scan order indicated in FIG. 10B, the difference between the maximum value and the minimum value of the Av_ΔVmax periods is 17.5 H (=21.5−4.0), and the sum of the adjacent line difference is 123 H.

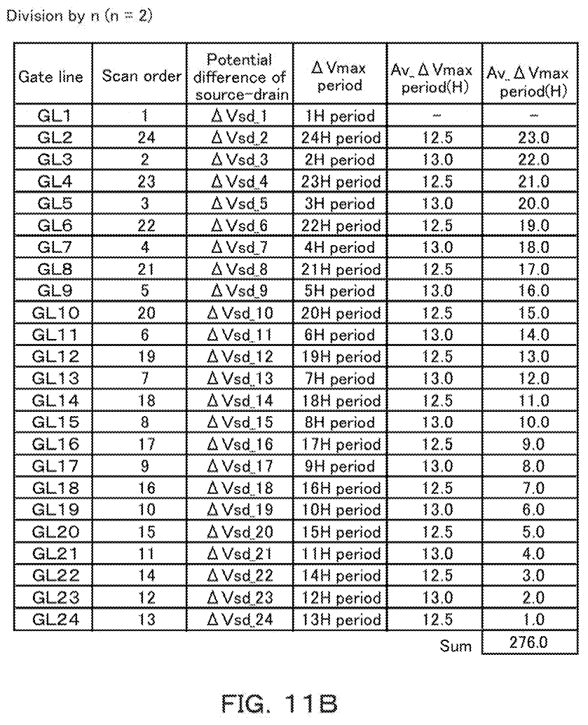

FIGS. 11A and 11B relate to comparative examples, indicating the ΔVmax periods, the Av_ΔVmax periods, and the adjacent line difference in a case where the 24 gate lines GL are driven in the conventional scan order and a case where the gate lines GL are divided into two groups to be driven as in the first embodiment, respectively.

When the gate lines are driven in the conventional scan order, the difference between the maximum value and the minimum value of the Av_ΔVmax periods is 22 H (=23.5-1.5), and the sum of the adjacent line difference is 23 H, as indicated in FIG. 11A. When the 24 gate lines are divided into the gate lines in the odd rows and the gate lines in the even rows to be driven, the difference between the maximum value and the minimum value of the Av_ΔVmax periods is 0.5 H (=13-12.5), and the sum of the adjacent line difference is 276 H, as indicated in FIG. 11B.

Driving the gate lines divided into the four groups (FIG. 10A) and driving the gate lines divided into the eight groups (FIG. 10B) are both lower in crosstalk reducing effect than driving the gate lines divided into the two groups (FIG. 11B) but are higher in crosstalk reducing effect than the conventional case (FIG. 11A). Driving the gate lines divided into the four groups (FIG. 10A) and driving the gate lines divided into the eight groups (FIG. 10B) are both higher in horizontal line reducing effect than driving the gate lines divided into the two groups (FIG. 11B).

Crosstalk reduction and horizontal line reduction accordingly have tradeoff relation. The number of divided groups of the gate lines is thus preferred to be determined in accordance with an allowable range of deterioration in display quality caused by crosstalk and horizontal line.

The modification example (1) provides the cases of dividing the gate lines into four and eight groups. The invention is, however, not limited to these cases in terms of the number of divided groups. The number of divided groups of the gate lines may be a natural number of two or more. In the above case, the gate driver 11 may be provided for each of the divided groups of the gate lines GL1 to GLM. Each of the gate drivers 11 may receive a gate start pulse from the display control circuit (not shown) before driving the first one of the gate lines GL to be driven by the corresponding gate driver 11.

(2) The first embodiment described above exemplifies dividing the gate lines GL1 to GLM into the gate lines in the odd rows and the gate lines in the even rows and driving the gate lines per divided group such that the scan directions are opposite to each other between the gate lines in the odd rows and the gate lines in the even rows to decrease variation in leakage current amount in one frame and reduce crosstalk. The present modification example includes decreasing variation in leakage current amount through a plurality of frames to reduce crosstalk, without dividing the gate lines GL1 to GLM.

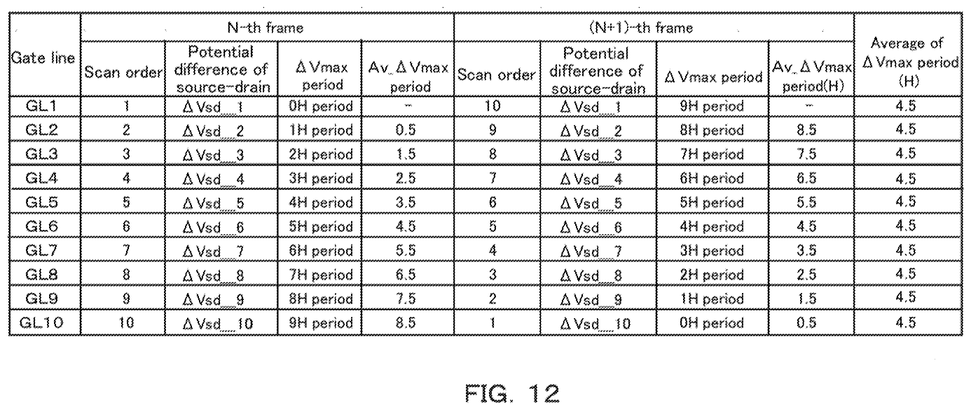

FIG. 12 is a chart indicating scan orders of the gate lines GL in the N-th frame and the (N+1)-th frame, the ΔVmax periods of the TFTs 121 connected to the gate lines GL, and the average values of the ΔVmax periods between the two frames. FIG. 12 exemplifies the case where the gate lines GL include ten gate lines as in the first embodiment. The invention is, however, not limited to this case in terms of the number of the gate lines GL.

As indicated in FIG. 12, the gate lines GL are driven in the order from the gate line GL1 to the gate line GL10 in the N-th frame, whereas the gate lines GL are driven in the order from the gate line GL10 to the gate line GL1 in the (N+1)-th frame. The gate lines GL are driven in the order of alignment of the gate lines GL in this exemplary case. There has only to be provided a single gate driver without necessity of providing gate drivers individually for the gate lines in the odd rows and the gate lines in the even rows as in the first embodiment.

The N-th frame has the conventional scan order in this case, so that the TFT 121 connected to the gate line GL10 to be driven lastly has the longest ΔVmax period. The (N+1)-th frame has the scan direction opposite to that of the N-th frame. In contrast to the N-th frame, the TFT 121 connected to the gate line GL1 to be driven lastly has the longest ΔVmax period. The pixel row in the rear portion has a larger leakage current amount in the N-th frame, whereas the pixel row in the front portion has a larger leakage current amount in the (N+1)-th frame. Variation in leakage current amount per frame is accordingly larger than that of the first embodiment. The average values of the ΔVmax periods of the TFTs 121 connected to the gate lines GL in the two frames are equal (4.5 H) to those of the first embodiment. The leakage current amounts of the pixel rows are thus uniformized through the two frames to achieve crosstalk reduction.

1. A liquid crystal display device comprising a display panel,
the display panel including
a plurality of gate lines,
a plurality of source lines crossing the plurality of gate lines,
a plurality of pixels defined by the plurality of gate lines and the plurality of source lines,
a plurality of switching elements each provided at a corresponding one of the pixels and connected to a corresponding one of the gate lines and a corresponding one of the source lines for the pixel, and
a plurality of pixel electrodes each provided at a corresponding one of the pixels and connected to the switching element at the pixel,
the liquid crystal display device further comprising:
a gate line drive circuit configured to scan the plurality of gate lines; and
a source line drive circuit configured to supply each of the source lines with a data signal; wherein
the source line drive circuit supplies the data signals inverted in polarity to adjacent ones of the source lines, the data signals being inverted in polarity per frame,
the gate line drive circuit divides the plurality of gate lines into at least two groups, and sequentially scans the gate lines once per group in one frame, and
the at least two groups include a group of the gate lines scanned in the one frame in a first direction in which the plurality of gate lines is aligned, and a group of the gate lines scanned in a second direction opposite to the first direction.

2. The liquid crystal display device according to claim 1, wherein the at least two groups include a first group of the gate lines in odd rows and a second group of the gate lines in even rows.

3. The liquid crystal display device according to claim 2, wherein the gate line drive circuit switches scan directions of the first group and the second group per frame.

4. The liquid crystal display device according to claim 2, wherein
the gate line drive circuit includes a plurality of first shift registers respectively connected to the gate lines in the first group and configured to scan the connected gate lines, and a plurality of second shift registers respectively connected to the gate lines in the second group and configured to scan the connected gate lines, and
the plurality of first shift registers is disposed in a frame region at first ends of the gate lines, and the plurality of second shift registers is disposed in the frame region at second ends of the gate lines.

5. The liquid crystal display device according to claim 1, wherein
the at least two groups include at least three groups, and
each of the at least three groups includes the gate lines scanned in the one frame in a direction opposite to a direction of scanning the gate lines in groups foregoing or subsequent in scan order.
